(19) United States
(12) Patent Application Publication
(10) Pub. No.: US 2002/0042847 A1
(43) Pub. Date: Apr. 11, 2002

(54) Method for a network management system for processing event information, as well as management object, discriminator object and managed object for it

(75) Inventors: Martin Takats, Berlin (DE); Elke Hain, Birkenwerder (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: Alcatel

(21) Appl. No.: 09/968,912

(22) Filed: Oct. 3, 2001

(30) Foreign Application Priority Data
Oct. 5, 2000 (DE) 100 49 609.1

(51) Int. Cl. G06F 9/46; G06F 9/00

(52) U.S. Cl. 709/316; 709/318

(57) ABSTRACT

The present invention concerns a method for a network management system for the transmission of event information, as well as a discriminator object, a management object, and a managed object for it. According to the method, the managed object sends event information to the management object which determines, on the basis of filter criteria, which of the event information relates to events to be sent to the management object. For this, it is proposed that the management object or a time-controlled control program sends to the discriminator object a first request message for the purpose of querying at least one event status of the managed object, whereupon the discriminator object sends a second request message to the managed object for the purpose of querying its event status. The managed object provides notification of its event status to the discriminator object, which checks the notified event status on the basis of filter criteria and reports it to the management object if the at least one event status relates to an event which is relevant to the management object.

### BACKGROUND OF THE INVENTION

The present invention concerns a method for a network management system for the transmission of event information as well as a discriminator object, a management object, and a managed object for it.

The invention is based on a priority application DE 100 49 609.1 which is hereby incorporated by reference.

In a network management system for a computer network with a so-called open system architecture, for example, a telecommunications network, upon the occurrence of an event the systems managed by the network management system, the so-called managed objects, which represent, for example, a switching centre, a router or a network service, spontaneously send event notifications to at least one system managing them, a so-called management object. The event notifications relate, for example, to a fault in the managed object, the exceeding of a limiting value or the alteration of the configuration status of the managed object. The management object, for example, the computer of a network management centre or a network management process executed by a computer, displays the spontaneous event notifications, on an operator interface for example and, for the purpose of remedying a fault condition, for example, sends control commands to the system to be controlled, i.e., the computer network and/or the managed object.

Depending on the responsibility or design of a management object, however, not all spontaneous event notifications which can potentially be sent by a managed object are relevant to the respective management object. For this reason the event notifications are preprocessed, in a solution known from the ITU Recommendation X.734 (ITU = International Telecommunication Union), by so-called event forwarding discriminators (EFD). An EFD receives event notifications sent from one or more managed objects and, on the basis of filter criteria, known as a “discriminator construct”, filters out those event notifications which are irrelevant to the management object. The spontaneous event notifications fulfilling the filter criteria, which are relevant to the management object, are sent by an EFD as so-called event reports to the respective management object.

The term event notifications refers to notifications which are sent spontaneously upon the occurrence of an event, whereas event status messages relate to events which may already have occurred a relatively long time ago. The general term “event information” denotes event notifications and event status messages. Event statuses and event notifications relate not only to normal object attributes, such as “operational” or “non-operational”, but also, for example, to so-called environmental alarms for indicating, e.g. a fire alarm.

An EFD only forwards to the management object event notifications which are sent spontaneously by the managed object upon the occurrence of an event. If, for example, a management object and an EFD assigned to it are operated on different computer systems, however, the transmission of the event notifications can be interrupted temporarily, e.g. due to a power overload or a connection fault, so that spontaneous event notifications are lost and the management object no longer knows the instantaneous event status of the respective managed object. The management object could interrogate, for example, a so-called log register in which the respective event notifications are entered, e.g. in the sequence of their entry. However, the management object would then have to expend resources on deriving a current event status of the managed object from what are only historically recorded event notifications.

### SUMMARY OF THE INVENTION

The object of the present invention, therefore, is to optimize, in a network management system, the processing of event information which a management object requires from a managed object.

This object is achieved by a method for a network management system for processing event information the method comprising:

at least one object managed by a management object forwards event information;

determining on the basis of filter criteria, which of the event information relates to events to be sent to the management object;

the management object or a time-controlled control program sends to a discriminator object a first request message for the purpose of querying at least one event status of the at least one managed object;

the discriminator object sends a second request message to the at least one managed object for the purpose of querying the at least one event status;

the at least one managed object provides notification of the at least one event status to the discriminator object; and

the discriminator object checks the at least one notified event status on the basis of the filter criteria and reports it to the management object if the at least one event status relates to an event which is relevant to the management object.

This object is achieved by a discriminator object for a network management system for processing event information, which comprises receiving means for receiving event information which is sent by at least one object managed by a management object and assigned to the discriminator object, and which comprises filter means, functioning on the basis of filter criteria, for determining the event information which relates to events to be sent to the management object, wherein

the receiving means are designed for receiving a first request message sent by the management object or a time-controlled control program for the purpose of querying at least one event status of the at least one managed object,

the discriminator object comprises sending means for sending a second request message to the at least one managed object for the purpose of querying the at least one event status,

the receiving means are designed for receiving the at least one event status notified to the second request message, and

the sending means and the filter means are designed so that the discriminator object can check the at least one event status on the basis of the filter criteria and report it to the management object if the at least one event status relates to an event which is relevant to the management object.

This object is achieved by a management object for a network management system for processing event information, the management object comprising receiving means for receiving event messages which relate to events of at least one object managed by the management object, wherein

the receiving means are designed for receiving a report, sent by a discriminator object, concerning at least one event status of the at least one managed object, and

the comprises storage means for storing the at least one event status of the at least one managed object.

This object is achieved by a managed object, for processing event information in a network management system, which comprises sending means for forwarding event information, characterized in that it comprises storage means for carrying at least one event status, it comprises receiving means for receiving a (second) request message, sent by a discriminator object, for the purpose of querying the at least one event status and the sending means are designed for sending the at least one event status to the discriminator object.

The invention is based on the concept that a management object can query a current event status of at least one managed object from a discriminator object, e.g. on the basis of an operator command. The management object can be, for example, a network management computer or a network management program with one or more processes executed on a computer. The querying of the event status can also be initiated by a time-controlled control program, assigned to the discriminator object or the management object, which, for example, cyclically updates an event status stored in the management object. The discriminator object, which is formed by a discriminator computer, but preferably by a process or a group of processes executed by a computer, interrogates the respective managed object, representing, for example, a switching centre or a service, for its event status. For this purpose there is operated in the memory of the managed object an event mirror which reflects the event status of the managed object. Entered in the event mirror, for example, are whether a function is faulty or operational or which configuration data have just been loaded. The managed object notifies the discriminator object of its event status. On the basis of filter criteria, the discriminator object filters the event status notified by the managed object and forwards to the management object only that portion which relates to events relevant to the management object.

The discriminator object, advantageously, reports to the management object only those events which indicate the current status of the at least one managed object. If an event is superseded by a new event, for example, if a fault or a limiting value infringement no longer exists, it is not reported to the management object.

In a variant of the invention, the discriminator object filters out superseded events whereas, in another variant, the at least one managed object already sends to the discriminator object only those event notifications which relate to a current status. Mixed forms of these two variants are easily realizable.

The discriminator object can report the at least one event status directly to the management object, for example, by means of its address, which it has specified in the request message for the purpose of querying the event status. It is also possible, however, for the discriminator object to report the at least one event status to the management object via a forwarding object, e.g. via the initially mentioned event forwarding discriminator (EFD) according to the ITU Recommendation X.734. The EFD then, for example, enters in the respective event messages, by means of an assignment table, the physical address of the management object which is assigned to a logical address predefined by the discriminator object in the respective event message.

In a further variant of the invention, the discriminator object reports to the management object not only a queried event status but also event notifications sent spontaneously by the at least one managed object upon the occurrence of an event. The discriminator object according to the invention thus also performs, for example, the functions of the initially mentioned event forwarding discriminators.

At least one applicable filter criterion can be respectively assigned to a discriminator object according to the invention. It is also possible, however, for the filter criteria to be respectively applied by the discriminator object, for example, the initially mentioned “discriminator construct”, to be individually determinable by the management object. For this purpose, the respectively applicable filter criteria for an event report can be sent to the discriminator object by the management object. In addition, the management object could also send an identifier by means of which the discriminator object can determine the filter criteria to be used.

In a preferred variant of the invention, the management object addresses the request message to the discriminator object with an object name from which criteria are determinable, particularly filter criteria to be used for the thus queried event report. From the point of view of the management object or objects, there are thus several separate logical discriminator objects, each denoted by an individual object name. Depending on the object name with which the discriminator object is, as it were, “spoken to ”, it interrogates one or more managed objects and then applies the respective filter criteria to the respectively notified event statuses.

It is then advantageous if there is connected ahead of the discriminator object a request manager which forwards to the discriminator object, via a transmission channel assigned to the object name used, preferably a so-called logical transmission channel, a request message sent by the management object. The discriminator object determines, by means of the transmission channel used by the request manager, the managed objects to be interrogated for the purpose of processing the request message and/or the filter criteria to be applied.

It is also possible, in principle, for the request manager to send to the discriminator object on a common transmission line the request messages which contain the different object names as address information and to add to the respective request message the filter criteria to be applied or an identifier concerning which filter criteria are to be applied.

In any case, by means of the various object names, a single discriminator object can, as it were, simulate different logical discriminator objects or discriminator agents and is thus universally applicable.

It is understood that any combinations of the measures indicated in the sub-claims, as well as in the description, are possible.

### BRIEF DESCRIPTION OF THE DRAWINGS

The invention and its advantages are described below with reference to an embodiment example and with the aid of the drawing.

FIG. 1 shows a schematic arrangement for execution of the method according to the invention, with management objects MO1, M02, discriminator objects DO1, DO2, managed objects VO1, VO2 and VO3 and a request manager RM.

FIG. 2 shows schematically, and exemplarily for the managed objects VO1, VO2, VO3, the managed object VO1.

FIG. 3 shows schematically, and exemplarily for the discriminator objects DO1 and DO2, the discriminator object DO1.

FIG. 4 shows schematically, and exemplarily for the management objects MO1, M02, the management object MO1.

FIG. 5 shows the request messages AN1 and AN2.

FIG. 6 shows the request messages AN3 and AN4.

### DETAILED DESCRIPTION

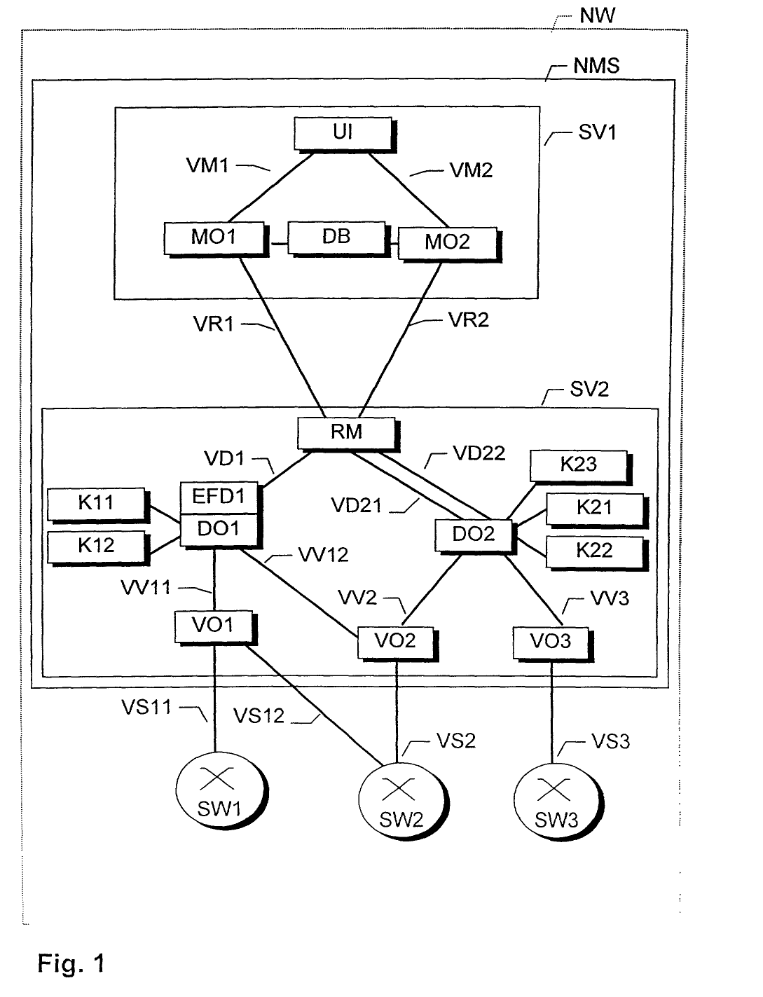

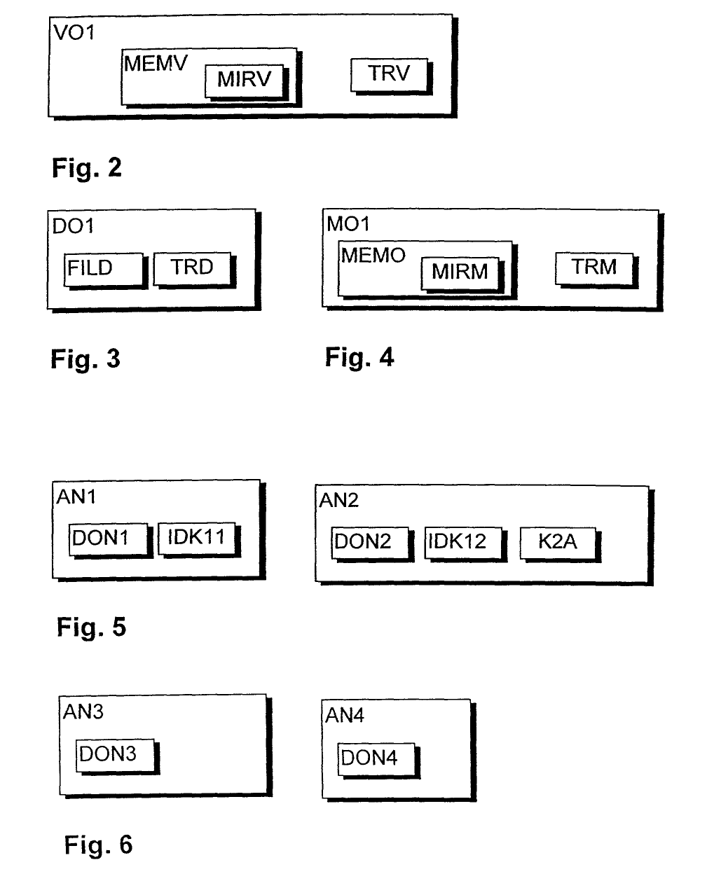

FIG. 1 shows a telecommunications network NW with servers SV2 and SV1 of a network management systems NMS with an open system architecture, as well as network facilities SW1, SW2 and SW3 which are, for example, switching centres, routers or service computers for the provision of services of an intelligent network (IN). The network facilities SW1, SW2 and SW3 are each managed, maintained and operated through the network management system NMS. The telecommunications network NW also comprises other facilities which are not represented, for example, further network facilities or terminals serviced by the network facilities SW1, SW2 and SW3. The network facilities SW1, SW2 and SW3 are represented by so-called managed objects VO1, VO2 and VO3 respectively. In the present case, the managed objects VO1, VO2, VO3 are processes or groups of processes whose program code is executed by the server SV2 and which preprocess the event information sent to the network management system NMS by the network facilities SW1, SW2 and SW3. Moreover, the network facilities SW1, SW2 and SW3 can be controlled via the managed objects VO1, VO2, VO3. The managed objects VO1, VO2, VO3 are, for example, so-called proxy agents which simulate the network management system NMS, at least in respect predefined attributes. A proxy agent converts the instructions sent by the network management system NMS so that they are understood by the managed network facilities SW1, SW2 and SW3. The managed objects VO1, VO2, VO3 can also represent only defined attributes of the network facilities SW1, SW2 and SW3, for example, their alarms.

It is also possible, however, for separate managed objects to be respectively provided for the purpose of controlling the network facilities SW1, SW2 and SW3 and processing event information from them. Further objects, similar to the managed objects VO1, VO2, VO3, could be provided to represent a network service or other resource of the telecommunications network NW. Moreover, several managed objects could be assigned to a resource and represent the latter differently. For example, the managed object VO1 could represent the alarms of the network facility SW1 and the managed object VO2 could represent its measured values or its currently loaded configuration data. The managed objects VO1, VO2, VO3 could also be formed directly through the network facilities SW1, SW2 and SW3 respectively, or be processes executed by the latter.

For the purpose of management, operation and maintenance of the managed objects VO1, VO2, VO3, management objects MO1, MO2 are provided which are designed as processes or groups of processes executed by the server SV1. It is also possible that the server SV1 itself forms a management object or that each of the management objects MO1, MO2 is a process executed by a separate computer of the network management system. Additionally provided in the server SV1 in the present case is an operator interface UI via which events notified by the network facilities SW1, SW2 and SW3, for example, the infringement of a limiting value or an activation of newly loaded configuration data, is output on a display device, for example a monitor, as well as being output acoustically. An operator can also send commands to the network facilities SW1, SW2 and SW3 for the purpose of controlling them, for example, to activate or deactivate a connection.

The servers SV1 and SV2, which are not represented in greater detail, are computers or computer networks which are operated by a UNIX operating system or a Windows NT operating system. The servers SV1 and SV2 comprise sending and receiving means, for example, LAN or WAN interface cards, modems or the like, by means of which data can be sent and received. There are also respectively provided storage means, for example, hard disks and RAM chips, as well as control means, for example, a processor or a cluster of processors respectively. Such a control means executes commands of an operating system which is stored in the storage means. Additionally stored in the storage means are program code sequences of program modules which are executed by the control means and control the functions of the servers SV1 and SV2. In the server SV1, such program modules are the management objects MO1 and MO2 and the operator interface UI and, in the server SV2, for example, the managed objects VO1 to VO3. The sending and receiving means, control means and storage means of the servers SV1 and SV2, and their respective internal interconnections, are not represented in FIG. 1.

The network facilities SW1 and SW2 send event information to the managed objects VO1 and VO2 respectively via connections VS11 and VS12 respectively.

The network facilities SW2 and SW3 send event information to the managed objects VO2 and VO3 respectively via connections VS2 and VS3 respectively. The network facilities SW1, SW2 and SW3 thereby notify, for example, infringements of limiting values, their current system load or traffic intensities of connections of the telecommunications network NW. The event information is sent, for example, as structured data, for example, by means of the basic encoding rules (BER) according to the definitions of the International Telecommunication Union. The event information between the network facilities SW1, SW2 and SW3 and the managed objects VO1, VO2, VO3 can also, however, be so-called object-request-broker (ORB) objects, e.g. according to the CORBA specification (CORBA = common object request broker architecture) of the OMG (Object Management Group) or the DCOM specification of the Microsoft company. The connections VS11, VS12, VS2, VS3 are represented in schematic form only and are preferably routed via a separate management network, for example, via a WAN (wide-area network).

Event information sent by the network facilities SW1, SW2 and SW3 is received by the managed objects VO1, VO2, VO3, via sending and receiving means TRV, and stored in a storage means MEMV. In the present case, the sending and receiving means TRV and the storage means MEMV are designed as corresponding program functions of the managed objects VO1, VO2, VO3. An image or a mirror MIRV of the events which have occurred in the network facilities SW1, SW2 and SW3 is thus respectively stored in the managed objects VO1, VO2, VO3.

The managed objects VO1, VO2, VO3, via connections VV11, VV12 and VV2, VV3, provide notification of the respective event information, as event information objects, to discriminator objects DO1 and DO2 respectively which, in the present case, are likewise designed as processes or agents executed by the server SV2. The discriminator objects DO1, DO2 receive the event information via sending and receiving means TRD and filter the event information on the basis of filter criteria K11, K12, K21, K22 by means of filter means FILD. In the present case, the sending and receiving means TRD and the filter means FILD are designed as corresponding program functions of the discriminator objects DO1, DO2, DO3 and form service provision means for the provision of services for the management objects MO1, MO2.

For example, the discriminator object DO1 filters the event information originating from the managed object VO1 and intended for the management object MO1 on the basis of the filter criteria K11, and the event information originating from the managed object VO2 and intended for the management object MO2 on the basis of the filter criteria K12. The filter criteria K11, K12 and K21, K22 are attributes of the discriminator objects DO1 and DO2 respectively and are designated as, for example, discriminator constructs. The filter criteria K11, K12 and K21, K22 set the conditions to be fulfilled by the event information sent by the managed objects VO1, VO2, VO3 if it is to be sent to the management objects MO1, MO2. The filter criteria K11, K12, K21, K22 can be in the form of, for example, check tables to be applied by the filter means FILD or check functions to be called by the filter means FILD. In any case, the filter means FILD filter out the event information relating to events which are respectively irrelevant to the management objects MO1, MO2, a non-critical infringement of a limiting value or a cyclically notified measured value being separated out, for example, whereas a critical fault or another alarm is forwarded.

Event information which has not been filtered out is sent by the discriminator objects DO1 and DO2, via connections VD1 and VD21, VD22 respectively, to a request manager RM which forwards the event information, via connections VR1 and VR2, to the management objects MO1 and MO2 respectively. The discriminator object DO1 enters in the event information sent by it only a logical address of the management objects MO1, MO2, whereas a forwarding object EFD1, for example, an event forwarding discriminator (EFD) according to the ITU Recommendation X.734 (ITU = International Telecommunication Union), which is connected ahead of the discriminator object DO1 towards the request manager RM, enters in the respective event information a physical address assigned to the respective logical address. The discriminator object DO2, on the other hand, already enters the necessary physical addresses without involvement of a forwarding object.

For the discriminator object DO1, there can be provision whereby, for example, it forwards to the forwarding object EFD1 all event information, i.e., not only that intended for forwarding but also that to be filtered out, but adds to it “forward” or “non-forward” attributes determined on the basis of the filter criteria K11 and K12.

It is also possible that a discriminator object at least partially duplicates event information sent by managed objects and forwards it multiply to management objects assigned to it. For example, the discriminator object DO1 could send event information notified by the managed objects VO1, VO2 to each of the two management objects MO1, MO2. The discriminator object DO1 receives the event information, for example, as input objects, and determines on the basis of the filter criteria K11 and K12 which of the input objects are to be sent to the management object MO1 and which to MO2. If necessary, the discriminator object DO1 copies such an input object in order to send it to both the management object MO1 and the management object MO2. In any case, the discriminator object DO1 adds to the input objects, as attributes, the logical addresses of the management objects MO1, MO2 respectively and then supplies them to the forwarding object EFD1.

The management objects MO1, MO2 receive, via sending and receiving means TRM, the event information sent by the discriminator objects DO1 and DO2 and store the event information in, for example, event mirrors MIRM which are provided in their storage means MEMO. In the embodiment example, the management objects MO1, MO2 additionally store the event information in a databank DB of the server SV1. In addition, the management objects MO1, MO2 forward the event information, for example, via internal connections VM1, VM2, preferably in the form of inter-process connections, provided in the server SV1, to the operator interface UI for output for an operator. In the present case, the sending and receiving means TRM and the storage means MEMO are designed as corresponding program functions of the management objects MO1, MO2.

The connections VR1 and VR2 are routed, for example, via a LAN (local area network) connecting the servers SV1 and SV2. The connections VV11, VV12, VV2, VV3 as well as VD1, VD21, VD22 are internal connections in the server SV2 which are routed via physical but, in particular, via logical transmission channels and are established, for example, through inter-process communication mechanism provided, for example, by the operating system of the server SV2.

Data transmission on the connections VR1 and VR2 is effected using, for example, the CMIP Protocol (Common Management Information Protocol) of the OSI (Open Systems Interconnection) or the TCP/IP-based Simple Network Management Protocol (= SNMP; TCP/IP = Transmission Control Protocol/Internet Protocol), each of which is suitable for transmission of management information.

Provided that the depicted spontaneous transfer of event information through the network facilities SW1, SW2 and SW3 to the management objects MO1, MO2 operates without fault, the event status of the network facilities SW1, SW2 and SW3 are known in the server SV1. If, for example, the connections VR1, VR2 fail briefly due to a line fault, however, event information spontaneously notified by the network facilities SW1, SW2 and SW3 may possibly be lost.

If the management objects MO1, MO2 receive, for example, from a monitoring process of the server SV1, not represented, a notification that such a line fault is “working”, i.e., is no longer present, they send request messages to the discriminator objects DO1 and DO2 to query the event statuses of the managed objects VO1, VO2, VO3 in order thus, for example, to re-update their event mirror MIRM and the databank DB.

The discriminator objects DO1 and DO2 respectively thus form service objects and the management objects MO1, MO2 form request objects, the service objects providing services for the request objects. The management objects MO1, MO2 could also be designated as managers and the discriminator objects DO1 and DO2 as agents.

It is also possible for commands to be sent from the operator interface UI to the management objects MO1, MO2 which initiate request messages directed to the discriminator objects DO1 and DO2. Furthermore, the discriminator objects DO and DO2 and/or the managed objects VO1, VO2, VO3 could notify the management objects MO1, MO2 that a divergence has occurred between the respective event mirrors MIRV and MIRM, whereupon the management objects MO1, MO2 send corresponding request messages to the discriminator objects DO1 and DO2 for the purpose of querying the event status.

In addition, request messages could be sent by a time-controlled control program provided in the server SV1 and/or in the server SV2. The time-controlled control program sends the request messages to the discriminator objects DO1 and DO2 at predefined times, for example, once hourly or on certain days of the week. The time-controlled control program could be a so-called external scheduler, executed as a separate process, or, alternatively, an internal scheduler which is, for example, integrated as a program function into the management object MO1 or into the discriminator object DO1.

Using as an example the request messages AN1 and AN2, with which the management object MO1 requests from the discriminator object DO1 the respective event statuses of the managed objects VO1 and VO2, a first variant for the processing of such request messages is to be described below. The request messages AN1 and AN2 are, for example, so-called “GET”, “EVENT REPORT” or “ACTION” messages, which are defined within the scope of the Common Management Information Services (CMIS), or are corresponding SNMP request messages. It is also possible for the request messages AN1 and AN2 to be sent in other forms of objects, for example, in the form of CORBA objects. The objects can then be transmitted using the above-mentioned OMG-defined Internet Inter-Object Request Broker Protocol (IIOP), which can be transmitted within the scope of the TCP/IP (= Transmission Control Protocol/Internet Protocol). Moreover, the request messages AN1 and AN2 could also be so-called remote-procedure-calls (RPCs), with which the management object MO1 calls the managed objects VO1 and VO2 respectively, designed as processes or “procedures”, in the server SV2.

The management object MO1 sends the request messages AN1 and AN2, via the connection VR1, to the request manager RM which receives the request messages AN1 and AN2 by means of sending and receiving means, which are not represented in greater detail and are in the form of, for example, program functions, and forwards them to the discriminator object DO1. In the request message AN1, “DON1” is specified as an object name and, consequently, as an address specification for the discriminator object DO1, “DON2” being specified as an object name and address specification in the request message AN2. The object names DON1 and DON2 are assigned to the discriminator object DO1 and are used for logical addressing of the latter. From the point of view of the management object MO1, there are thus two service objects: a discriminator object, designated by DON1, which as a service queries the event status of the managed object VO1, and a discriminator object, designated by DON2, which as a service queries the event status of the managed object VO2. Depending on the respectively requested service, the sending and receiving means TRM of the management object MO1 enter the object names DON1 or DON2 in the respective request message.

The request manager RM determines, on the basis of the object names DON1 or DON2, for example, by means of an object-name-to-service-object assignment table and/or a predefined assignment algorithm, that the request messages AN1 and AN2 are intended for the discriminator object DO1. Moreover, it is also possible for the request manager RM to insert in the request messages AN1 and AN2 an additional identifier by means of which the discriminator object DO1 can determine the service to be provided in each case.

The discriminator object DO1 receives the request messages AN1 and AN2 with its sending and receiving means TRD. On the basis of the object names DON1 and DON2, which serve as an identifier, the discriminator object DO1 identifies which service it is to provide, namely, that it is to report the event statuses of the managed objects VO1 and VO2 respectively to the management object MO1. A corresponding assignment of the object names DON1 and DON2 to a respective service to be provided is advantageously stored in the configuration data of the discriminator object DO1.

For the purpose of processing the request messages AN1 and AN2, the discriminator object DO1 sends, via each of the connections VV11 and VV12 respectively, a query message to query the event status of the managed objects VO1 and VO2 respectively. The latter notify the discriminator object DO1, in single event status messages or in a coherent event status report, of the event statuses, stored in their respective event mirrors MIRV, of the network facilities SW1 and SW2 respectively. It is also possible that the managed objects VO1, VO2 additionally send query messages to the network facilities SW1, SW2 for the purpose of querying their respectively current event states, for example, to query faults.

The discriminator object DO1 receives the event status messages via its sending and receiving means TRD and, by means of the filter means FILD, checks whether the event status messages relate to events which are relevant to the management object MO1. The filter means could apply the filter criteria K11 and K12, in the manner stated above, to filter the event status messages originating from the managed objects VO1 and VO2 respectively. The object names DON1 and DON2 would then be identifiers for determining the applicable filter criteria K11 and K12 respectively, which are a constituent part of the configuration data for the discriminator object DO1. In the present case, however, there are specified in the request messages AN1 and AN2 their own identifiers IDK11 and IDK12 respectively, which the discriminator object DO1 instructs for the application of the filter criteria K11 and K12 respectively for the event status messages notified by the managed objects VO1 and VO2 respectively. There are also additionally specified in the request message AN2 further filter criteria K2A which are to be used for filtering event statuses. For example, it can be determined in the filter criteria K2A that only alarm statuses, but no measurement values, of the managed object VO2 are to be reported to the management object MO1.

Further specifications, which are not explained more fully, can also be contained in the request messages AN1 and AN2, for example, the address of the management object MO1, which serves as a destination address for the acknowledgement of the event statuses.

If the event status message contains the status of an event which is irrelevant to the management object MO1 it is filtered out, otherwise the event status is reported to the management object MO1 via the request manager RM. If necessary, the respective message is reformatted by the discriminator object DO1 into a message form which is intelligible to the management object MO1.

In the present example, the managed objects VO1 and VO2 each give notification only of currently valid event statuses. In principle, the discriminator object DO1 could also check whether a notified event status is currently valid. For example, if measured values are to be transferred cyclically, it is possible to ascertain, on the basis of time information added to a particular measured value, whether a predefined transmission cycle for the measured value has been observed.

The management object MO1 receives the event status messages or the event status reports from the discriminator object DO1 via its sending and receiving means TRM and updates the respective events in its event mirror MIRM as well as in the databank DB. Means can then be provided in the management object MO1 for checking the plausibility of the events, for example, time information appended to a notified event status could be compared with time information recorded for a stored event status. In addition, the means for plausibility checking could determine a variation of a status of an event in the event mirror MIRM in relation to an event status notified by the discriminator object DO1. If such a variation occurs, a warning message, for example, is output to the operator interface UI and, in addition, a security query is sent to the managed object notifying the event status and/or the discriminator object, in which the latter are instructed to check whether the notified variation of the event status is correct.

Using as an example the request messages AN3 and AN4, with which the management object MO2 requests from the discriminator object DO2 the event statuses of the network facilities SW2 and SW3 respectively, a second variant for the processing of request messages sent by a request object to a service object is to be described below.

The management object MO2 sends to the request manager RM the request messages AN3 and AN4, in which the object names DON3 and DON4 respectively are specified as logical addresses. From the point of view of the management object MO2, acting as a request object, there are thus two independent service objects DON3 and DON4. The connections VD21 and VD22 respectively are assigned, as logical transmission channels, to the logical service objects DON3 and DON4. The request manager RM determines, for example, on the basis of an object-name-to-transmission-channel assignment list, that it is to send the request message AN3 to the discriminator object DO2 on the connection VD21 and the request message AN4 on the connection VD22.

From the fact that it receives the request message AN3 on the connection V21, the discriminator object DO2 determines that it is to provide a first service for the management object MO2, namely, the notification of the event status of the managed object VO2. Accordingly, it sends a query message or request message, via the connection VV2, to the managed object VO2 which responds to it with one or more messages concerning its event status. These messages are filtered by the discriminator object DO2 on the basis of the filter criteria K21 which are to be applied to request messages obtained on the connection VD21.

The same applies to the request message AN4, received on the connection VD22, in which a second service is requested from the discriminator object DO2: the querying of the event status of the managed object VO3. The discriminator object DO2 therefore queries this event status via the connection VV3 and, by means of the filter criteria K22, which are assigned to request messages received on the connection VD22, filters the response messages which are then received.

The event information reported to the management object MO2 by the discriminator object DO2 and fulfilling the filter criteria K21 and K22 is entered by the management object MO2 in its event mirror MIRM, in the manner described above.

It is only on the basis of the assignment of a logical transmission channel VD21 and VD22 to a respective service to be provided that the discriminator object DO2 can determine this service. In principle, therefore, the request messages AN3 and AN4 or request messages derived from them could also be sent by the request manager RM to the discriminator object DO2 without the object names DON3 and DON4 respectively as identifiers for the service to be provided.

It is also possible for a discriminator object to receive on a transmission channel request messages relating to different services and/or different management objects. For example, the discriminator object DO2 could receive on the connection VD21 the request messages AN3 and AN2, which each relate to a querying of the event status of the managed object VO2 and in which the address of the management objects MO2 or MO1 is specified as a source/destination identifier. The discriminator object DO2 then interrogates the managed object VO2, in the manner explained above, querying its event status. The event information which is then received is filtered by the discriminator object DO2 on the basis of the filter criteria K21 insofar as it relates to the source/destination identifier MO2, i.e., the management object MO2, and on the basis of the filter criteria K23 insofar as it relates to the management object MO1.

Variants and developments of the invention are easily achievable:

The discriminator objects DO1 and DO2 could be provided only for querying event statuses from the managed objects VO1, VO2, VO3. Separate objects or agents, for example, EFDs, could be provided for event messages sent spontaneously by the latter.

The discriminator objects DO1 and DO2 serving as service objects could also derive the respective service to be provided, in the embodiment example, the filter criteria to be applied for the event status reports, from a source identifier of the management objects MO1, MO2 acting as request objects. If the discriminator object DO1 receives, for example, a request message by the management object MO1, it sends all the event statuses relating to the managed object VO1 whereas, in the case of a request message sent by the management object MO2 with, if applicable, the same address for the discriminator object DO1 as in the request message sent by the management object MO2, it sends only a selection of event statuses, for example, particularly critical alarm statuses. General information, by contrast, such as cyclic measurement values, is separated out on the basis of filter criteria which are not represented.

The discriminator objects DO1 and DO2 acting as logical service objects could each be constructed as a cascade of processes or agents with, for example, a central control process or control agent receiving the request messages from the management objects MO1, MO2 acting as request objects and distributing them to sub-processes or sub-agents.

The discriminator objects DO1 and DO2 could be integrated either wholly or partially, in partial functions, into the managed objects VO1, VO2, VO3.

The functions of the discriminator objects DO1 and DO2 can be designed to be controllable by the management objects MO1, MO2 and/or by the request manager RM. For example, the spontaneous sending of event notifications by the discriminator objects DO1 and DO2 could be inhibited or enabled by the management objects MO1, MO2.

Furthermore, the discriminator objects DO1 and DO2 could provide notification of their respective status to the management objects MO1, MO2 and/or the request manager RM. For example, the discriminator objects DO1 and DO2 could provide notification of their object creation, their object deletion, their operational or non-operational state or a configuration data change or attribute value change.

The management objects MO1, MO2, the request manager RM, the discriminator objects DO1 and DO2 and the managed objects VO1, VO2, VO3 could each be realized separately or in groups of computers or computer networks at a distance from one another. Furthermore, other assignments could be provided. For example, the management object MO1 and the discriminator object DO2 could be assigned to the server SV1 and the management object MO2 and the discriminator object DO1 assigned to the server SV2. For the purpose of matching the event statuses stored respectively in the servers SV1 and SV2, the management object MO1 could send request messages to the discriminator object DO2 and the management object MO2 could send request messages to the discriminator object DO1.

In addition, the servers SV1 and SV2 could belong to network management systems which are separate from, but networked to, one another.

Unlike the examples shown, in which the management objects, the managed objects and the discriminator objects are each designed as processes or process groups whose program code is executed by a computer or computer network, the objects could also be formed, as is were, by hardware. For example, the managed objects VO1 and VO2 could be formed by the network facility SW1 and SW2 respectively and the discriminator object DO1 by a server assigned to the managed objects VO1, VO2.

1. Method for a network management system for processing event information the method comprising:
at least one object managed by a management object forwards event information;
determining on the basis of filter criteria, which of the event information relates to events to be sent to the management object;
the management object or a time-controlled control program sends to a discriminator object a first request message for the purpose of querying at least one event status of the at least one managed object;
the discriminator object sends a second request message to the at least one managed object for the purpose of querying the at least one event status;
the at least one managed object provides notification of the at least one event status to the discriminator object; and
the discriminator object checks the at least one notified event status on the basis of the filter criteria and reports it to the management object if the at least one event status relates to an event which is relevant to the management object.

2. Method according to claim 1, wherein the at least one event status notified by the managed object is currently valid.

3. Method according to claim 1, wherein the discriminator object checks whether the at least one event status notified by the managed object is currently valid.

4. Method according to claim 1, wherein the discriminator object reports the at least one event status directly to the management object.

5. Method according to claim 1, wherein the discriminator object reports the at least one event status to the management object via a forwarding object.

6. Method according to claim 1, wherein the discriminator object receives event notifications sent spontaneously by the at least one managed object, checks the spontaneous event messages on the basis of the filter criteria and reports to the management object those event messages which relate to an event relevant to the management object.

7. Method according to claim 1, wherein the management object sends to the discriminator object, at least partially, the filter criteria to be used and/or an identifier on the basis of which the discriminator object can determine the filter criteria to be used.

8. Method according to claim 1, wherein the discriminator object determines the at least one managed object to be interrogated and/or the filter criteria to be used on the basis of a source identifier and/or destination identifier contained in the request message and/or on the basis of a transmission channel, in particular, a logical transmission channel, on which the discriminator object receives the first request message.

9. Method according to claim 1, the method comprising: assigning to the discriminator object at least a first and a second object name; the management object addresses the first request message to the discriminator object with the first or the second object name; the at least one managed object to be interrogated and/or the criteria to be used, in particular, the filter criteria to be used and/or at least one destination for the thus queried event report being determinable from the first or second object name used.

10. Method according to claim 9, wherein the management object sends the first request message to a request manager and the request manager forwards the first request message to the discriminator object, via a first or a second, in particular, logical transmission channel, which are respectively assigned to the first and second object names respectively used for the discriminator object.

11. Discriminator object for a network management system for processing event information, which comprises receiving means for receiving event information which is sent by at least one object managed by a management object and assigned to the discriminator object, and which comprises filter means, functioning on the basis of filter criteria, for determining the event information which relates to events to be sent to the management object, wherein
the receiving means are designed for receiving a first request message sent by the management object or a time-controlled control program for the purpose of querying at least one event status of the at least one managed object,
the discriminator object comprises sending means for sending a second request message to the at least one managed object for the purpose of querying the at least one event status,
the receiving means are designed for receiving the at least one event status notified to the second request message, and
the sending means and the filter means are designed so that the discriminator object can check the at least one event status on the basis of the filter criteria and report it to the management object if the at least one event status relates to an event which is relevant to the management object.

12. Discriminator object according to claim 11, wherein it comprises a program code which can be executed by a control means of a server.

13. Management object for a network management system for processing event information, the management object comprising receiving means for receiving event messages which relate to events of at least one object managed by the management object, wherein
the receiving means are designed for receiving a report, sent by a discriminator object, concerning at least one event status of the at least one managed object, and
the comprises storage means for storing the at least one event status of the at least one managed object.

14. Management object according to claim 13, wherein it comprises acquisition means for determining at least one condition on the basis of which the management object requires an event status of the at least one managed object, and comprises sending means for sending to the discriminator object a (first) request message for the purpose of querying at least one event status of the at least one managed object.

15. Management object according to either of claims 13 or 14, wherein it comprises program code which can be executed by a control means of a server.

16. Object, managed by a management object, for processing event information in a network management system, which comprises sending means for forwarding event information, characterized in that it comprises storage means for carrying at least one event status, it comprises receiving means for receiving a (second) request message, sent by a discriminator object, for the purpose of querying the at least one event status and the sending means are designed for sending the at least one event status to the discriminator object.

17. Managed object according to claim 16, wherein it comprises program code which can be executed by a control means of a server.

18. Storage means, in particular, diskette or CD-ROM, digital versatile disc, hard disk drive or the like, with a discriminator object according to claim 12 stored thereon and/or with a management object according to claim 15 stored thereon and/or with a managed object according to claim 17 stored thereon.
